(19) United States
(12) Patent Application Publication
(10) Pub. No.: US 2007/0290597 A1
(43) Pub. Date: Dec. 20, 2007

(54) Electron emission source and field emission display device

(75) Inventors: Jason Lo, Taipei City (TW); Jian-Min Jeng, Taipei City (TW)

Correspondence Address: BACON & THOMAS, PLLC, 625 SLATERS LANE, FOURTH FLOOR, ALEXANDRIA, VA, 22314, US

(73) Assignee: Tatung Company, Taipei City (TW)

(21) Appl. No.: 11/634,886

(22) Filed: Dec. 7, 2006

(30) Foreign Application Priority Data
Jun. 19, 2006 (TW) 095121848

(51) Int. Cl. H01J 9/02

(52) U.S. Cl. 313/310

(57) ABSTRACT

An electron emission source and a field emission display device are disclosed. The electron emission source includes a substrate and an electron emission layer formed on the substrate. The electron emission layer includes a composition of diamond-like carbon (DLC) film structures. The height of the DLC flakes is in micrometer scale, and the thickness of the DLC flakes is in nanometer scale. Hence, the aspect ratio of the DLC film structures is high. Therefore, the DLC film can be used as a good electron emission source. A conductive layer can be optionally deposited on the surface of the substrate for further enhancing DLC film in electron emission.

### BACKGROUND OF THE INVENTION

1. Field of the Invention

The present invention relates to an electron emission source, more particularly to a field emission display with an electron emission source.

2. Description of Related Art

Display devices have become particularly important in our daily lives. Aside from using PC systems or browsing the Internet, display devices are also used in TVs, mobile phones, Personal Digital Assistant (PDAs), and digital cameras for visual presentation of images and text. Compared to traditional cathode ray tubes (CRTs), newer flat panel displays have the advantages of being lightweight and compact, and are less harmful to human health.

Among the emerging flat panel display technologies, field emission displays (FEDs) appear to be the most promising display technique. FEDs, aside from gaining the same high display resolutions achieved by traditional CRTs, inherit none of the drawbacks of Liquid Crystal Displays (LCDs) such as narrow viewing angle, small operating temperature range, and slow response time. That is, FEDs have the advantages of high luminescent efficiency, fast response time, good display coordination, high luminance exceeding 100 ftL, structural compactness, wide viewing angle, large operating temperature range, and high working efficiency.

Another reason for the optimistic outlook concerning FEDs lies in their operation without need for backlight modules. Even in outdoor sunny environments, FEDs still perform well in the brightness category. For that reason, FEDs are already regarded as competing with LCDs in becoming the dominant display technology, and are expected to replace LCDs.

The FEDs operate similarly to cathode ray tubes under vacuum environments with a pressure of less than 10⁻⁶ torr, such that an electric field is used to pull out the electrons on the tip of the cathode, and under the acceleration by the positive voltage of an anode plate, the electrons impinge on the phosphor powder on the anode plate so as to create luminescence. Typically, FEDs control the variation of the voltage difference applied between a gate and the cathode, and cause each electron-emitter to emit electrons at a prescribed time.

To satisfy the need of a field emitter cathode, the work function and geometric construction of the field emitter cathode are ideally as small as possible. Given the short lifetime and manufacturing difficulty in prior art metal-coned electron emission elements, current research on the material for the electron-emitter of FEDs is primarily focused on the type of carbon with chemical stability, electrical conductivity, or low electron affinity. More specifically, the preferred carbon material includes amorphous carbon films, diamond films, diamond-like carbon films, and carbon nanotubes.

Due to the structural nature of high aspect ratio, carbon nanotubes have a characteristic of low threshold voltage and high current emission density, i.e. a good field enhancement factor, thus making carbon nanotubes a popular field emission material.

However, carbon nanotubes are not without shortcomings. The nano-scale nature in structure makes difficulty in distributing the carbon nanotubes evenly in the electron-emitter paste, resulting in uneven current distribution and shorter operating lifetime. Also, a tendency of enlarging surface area of nanotubes structure gives rise to its instability. Hence, there is a need for surface modification to the carbon nanotubes in order to improve field emission stability.

Diamond-like carbon (DLC) is primarily composed of amorphous carbon with SP³ three-dimensional and SP² planar structures. The SP³ structure has a lower electron affinity and a stronger mechanical property, and the SP² structure has a better conductive property; therefore, the DLC formed with these two structures achieves the benefits of both low electron affinity and better conductive property.

Thus there is a need to provide a diamond-like carbon electron emission material with a good field enhancement factor that not only has a high aspect ratio in structure, but also has a low electron affinity. Also, DLC has stable material properties that are favorable for the subsequent manufacturing processing of elements in becoming a good electron emission material.

### SUMMARY OF THE INVENTION

The object of the present invention is to provide an electron emission source and a field emission display, wherein the electron emission layer used for the electron emission source is a DLC composition that includes a plurality of micro-scale film structures.

The film structures in the DLC composition of the present invention have heights in micro-scale dimensions, and thickness in nano-scale dimensions. Thus, the DLC composition with plural micro-scale film structures of the invention has a high aspect ratio, giving rise to a good field enhancement factor favorable for electron emission and becoming a good electron emission source.

Also, radio frequency sputtering is used in the invention to deposit the DLC film, allowing a large area to be manufactured so as to reduce the time for preparation and the cost for manufacture.

The invention achieves the object by providing an electron emission source, including a substrate and an electron emission layer formed on the surface of the substrate. Preferably, the electron emission layer includes a composition of DLC with a plurality of micro-scale film structures.

The invention achieves the object by further providing another aspect of an electron emission source that includes a substrate, a conductive layer formed on the surface of the substrate, and an electron emission layer formed on the surface of the conduction layer. Preferably, the electron emission layer includes a composition of DLC with a plurality of micro-scale film structures.

The invention achieves the object by further providing a field emission display that includes an upper substrate having a phosphor layer and an anode layer, and a lower substrate having an electron emission layer and a cathode layer. The electron emission layer is closely adjacent to, and electrically connected with the cathode layer. Preferably, the electron emission layer includes a composition of DLC with a plurality of micro-scale film structures.

In the structural configuration of the present invention, the film structures of the DLC layer are formed on the surface of the substrate as a paste. The lateral height of the film structures is between 0.5 μm and 4.0 μm, and preferably is between 0.9 μm and 2.0 μm. The thickness of the film structures is preferably between 0.005 μm and 0.1 μm, and more preferably is between 0.005 μm and 0.05 μm. The film structures of the DLC film layer of the invention can have a micro-scale height and a nano-scale thickness, giving rise to a high aspect ratio favorable for electron emission.

In the embodiments of the present invention, the substrate material is preferably, but not limited to, semiconductor material or glass material. To enhance the electron emission effects, the invention further selectively includes a conduction layer on the surface of the substrate, disposed between the substrate and the DLC film layer. The conduction layer can be of any conductive material, preferably of Indium Tin Oxide (ITO), zinc oxide, Zinc Tin Oxide (ZTO), or metal material, such as silver epoxy.

In a preferred embodiment of the invention, when the substrate is constituted of glass material, the surface of the glass substrate is coated with a conductive layer to allow the film structures of the DLC film layer to be formed on the conduction layer surface more easily. The conductive layer provides a current to the film structures of the DLC film layer, which then can act as an electron emission source.

In another preferred embodiment of the invention, the substrate is constituted of a semiconductor material. Since the substrate material is conductive by nature, the film structures of the DLC film layer can be directly formed on the surface of the substrate so as to become an electron emission source.

The film structures of the DLC film layer of the electron emission source are preferably, but not limited to, long-strip film structures or curved film structures. The primary feature of the film structures is the high aspect ratio, which allows the DLC film layer of the invention to have a great film enhancement factor ideal for a good electron emission source. The electron emission source of the present invention can be applied in any technology fields requiring electron emission, preferably in cold cathode emitters such as field emission elements, field emission displays, or flat panel light sources.

In the field emission display of the invention, the electron emission layer composition preferably further includes an adhesive material, for better combining the DLC material and the conductive material to form an evenly mixed composition. The adhesive material is preferably, but not limited to, ethyl cellulose.

The field emission display of the invention further includes a gate electrode layer disposed between the upper substrate and the lower substrate. The gate electrode layer can be any gate electrodes traditionally used in field emission displays, and is preferably a ring gate electrode having a plurality of hollow holes. The gate electrode layer allows every electron-emitter to accurately emit electrons at prescribed times.

The upper substrate of the field emission display of the present invention can further include a photo-mask layer. The photo-mask layer can be disposed closely to the phosphor layer to mask off leaking light and to increase picture contrast.

In traditional field emission displays that use carbon nanotubes, due to the too small size of the carbon nanotubes, it is difficult to distribute evenly carbon nanotubes during the process of preparing electron emission source paste, causing the manufactured electron emission source to emit electrons unevenly. However, according to the present invention, the micro-scaled film structures of the DLC are more easily distributable in the composition, allowing manufacture of a field emitter that can emit electrons evenly. The field emission display of the invention can easily accomplish the making of an electron emission layer so as to satisfy the need of a field emission flat panel display requiring a large-scale glass substrate.

Compared to traditional carbon nanotubes material, the micro-scaled film structures of the DLC used by the invention require a relatively lower temperature for growth process, and can be directly grown on the substrate surface, and thus are favorable for application in fabrication. The film structures of the DLC of the invention have a high aspect ratio, hence a high field enhancement factor, making the invention applicable in a cold cathode emitting source such as field emission elements, field emission displays, or flat panel light sources.

Other objects, advantages, and novel features of the present invention will become more apparent from the following detailed description when taken in conjunction with the accompanying drawings.

### BRIEF DESCRIPTION OF THE DRAWINGS

FIG. 1 is a schematic view showing a sputtering reaction chamber used for making a DLC film layer according to a first embodiment of the present invention;

FIG. 2 is a Scanning Electron Microscope (SEM) photo of the DLC powder obtained in the first embodiment of the invention;

FIG. 3 is a schematic view illustrating a diode-type field emission testing apparatus for testing field emission effects according to the first embodiment of the invention;

FIG. 4 is a plot showing the result of the field emissions test performed on the electron emission source formed by mixing DLC powder into a paste composition according to a second embodiment of the invention;

FIG. 5 is a schematic view illustrating a triode-type field emission testing apparatus for testing field emission effects according to the second embodiment of the invention; and

FIG. 6 shows a plot of the field emission effects according to a third embodiment of the invention.

### DETAILED DESCRIPTION OF THE PREFERRED EMBODIMENT

### Embodiment 1

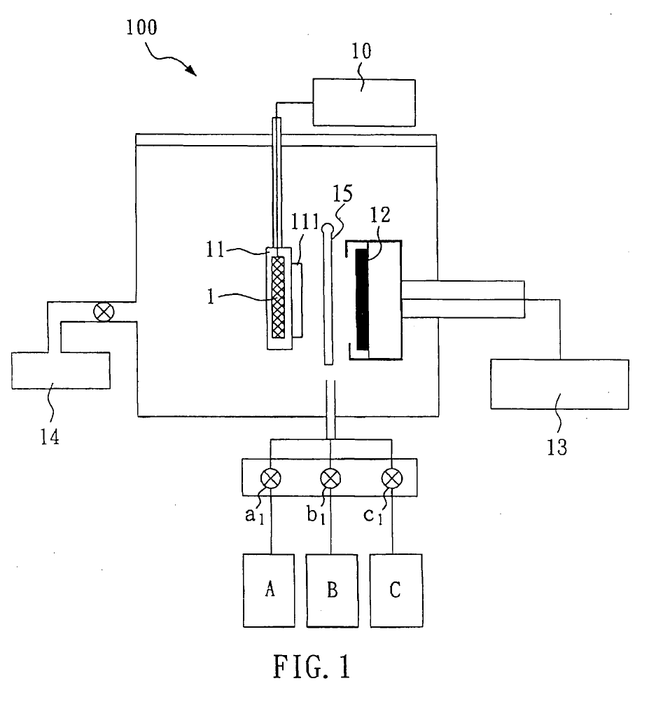

Below, a DLC film layer fabrication process according to the first embodiment of the present invention is described. FIG. 1 shows a schematic view of a sputtering reaction chamber 100 for making the DLC film layer according to this embodiment.

First, a reaction chamber 100 capable of performing sputtering is provided. The reaction chamber 100 includes a heater 10 and lamp 1 for heating a substrate 111, a loading platform 11 for supporting the substrate 111, a power supply 13 for applying voltage on a target material 12, and a plurality of gas supplying units A, B, and C for supplying reactant gas. During formation of the DLC film layer, the number of the gas supplying units can be increased or decreased depending on the gas conditions required for the process.

Then, the surface of the substrate 111 is cleaned and the substrate 111 is thereafter disposed on the loading platform 11 in the reaction chamber 100 so as to secure the substrate 111. In this embodiment, the substrate 111 is a semiconductor silicon wafer. Then, a vacuum pump device 14 removes air from the reaction chamber 100 to leave a pressure of under 1×10⁻⁵ torr, and lamp 1 the heater 10 heats the substrate 111 up to a temperature of 500° C. Then, the gases required for reaction are supplied by the gas supplying units A, B, C into the reaction chamber 100, and a mass flow controller (not shown) is provided for controlling the flow rates of the gases into the reaction chamber 100. The gas-supplying units A, B, and C in the embodiment are gas-supplying sources containing argon, methane, and hydrogen, respectively. Whether the gases are introduced into the reaction chamber 100 is determined by the manufacturing conditions, and the flow of the gases is regulated by gas supplying valves a1, b1 and c1. In this embodiment, the gases introduced into the reaction chamber 100 are argon, methane and hydrogen, with a ratio of 2:1:1, as indicated in table 1.

TABLE 1

| | Argon | Methane | Hydrogen |
|---|---|---|---|
| Embodiment 1 | 10 | 5 | 5 |

In this embodiment, when the reactant gases are introduced into the reaction chamber 100, the internal pressure is controlled to 9×10⁻³ torr. Of course, the surrounding pressure for a sputtering reaction according to this embodiment is not to be limited, but can be adjustable upon manufacturing needs.

Thereafter, the graphite target material 12 is pre-sputtered for 30 minutes with 200W of RF power so as to remove possible pollutants from the surface of the target material 12 as the shutter 15 is closed. Then, the shutter 15 is opened and the surface of substrate 111 undergoes sputtering for 70 minutes to grow a DLC layer on substrate surface.

### Embodiment 2

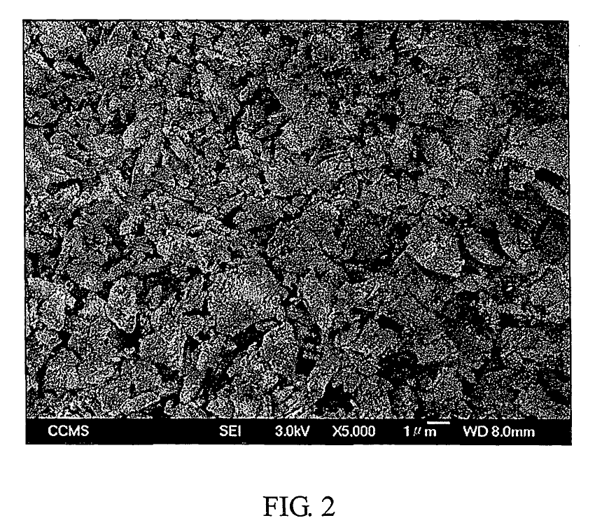

The DLC layer deposited on the substrate surface according to the first embodiment is removed for obtaining a DLC powder. The DLC powder is then mixed together with a silver powder and adhesives into a paste for use as an electron emission source material. FIG. 2 is an SEM (Scanning Electron Microscope) photo of the DLC powder obtained in the first embodiment.

A composition with 8.7% DLC powder, 8.7% glass powder and 82.6% silver powder is evenly mixed together, with addition of ethyl cellulose as adhesives, to form a paste for use as an electron emission source material. In this embodiment, a glass substrate with a conductive silver paste thereon is taken as a cathode plate. The above-mentioned electron emission source paste is coated on the silver paste surface so as to complete the cathode plate structure. In this embodiment, an anode plate is structurally equivalent to the one in the first embodiment.

The above-described structural combination is then tested through a diode type field emission testing apparatus for field emission effects.

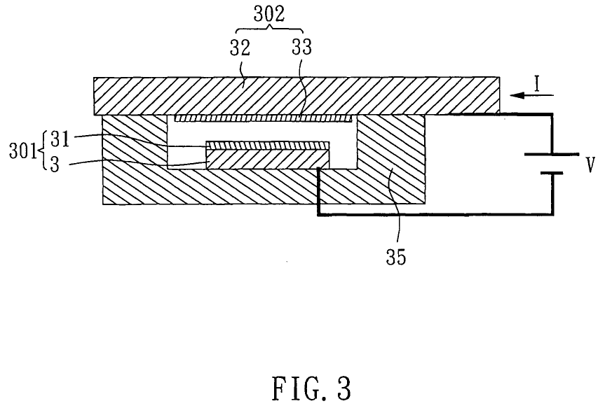

FIG. 3 is schematic view illustrating the diode configuration used for testing field emission effects according to the present embodiment of the invention. In the field emission test of this embodiment, a test film 3 of DLC film paste layer 31 is used as a cathode plate 301, and a substrate 32 with a luminance layer 33 is used as an anode plate 302. In this embodiment, the luminance layer 33 is a phosphor layer, and the ITO glass substrate 32 is a glass substrate having an ITO layer that acts as the anode layer (not shown).

First, a cathode plate 301 is emplaced in a container 35, and above which is covered with an anode plate 302. The container 35 is then placed inside a vacuum chamber and the pressure is reduced to below 1×10⁻⁶ torr. A voltage is applied between the two electrode plates 301 and 302 for measuring the magnitude of the current produced by the electron emission source of the cathode plate 301.

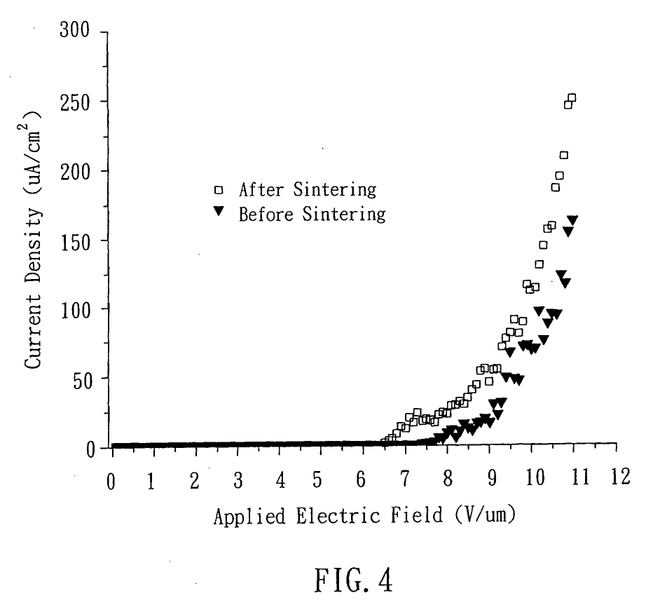

FIG. 4 shows the plot of the result of the field emissions test performed on the electron emission source formed by mixing DLC powder into a paste composition. As shown, a sintered electron emission source paste presents more superior field emission effects than an unsintered electron emission source paste. Namely, when the same voltage potential is applied between the two electrode plates, the electron emission source with a sintered substrate surface has a higher current flow.

### Embodiment 3

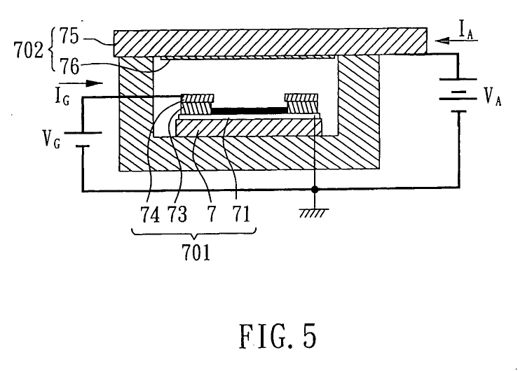

FIG. 5 is schematic illustrating a triode type field emission testing apparatus used in the present embodiment of the invention. In this embodiment, the electron emission source is same as the one used in the second embodiment. Namely, the same mixing composition is used to obtain the electron emission source paste.

As shown in FIG. 5, as compared with the diode-type field emission testing apparatus, the triode-type field emission testing apparatus of this embodiment has an additional gate electrode layer 74 on a cathode plate 701 and an insulating layer 73 for insulating the cathode layer 71 from the gate layer 74. Thus, the cathode layer 71, the gate electrode layer 74, and an anode layer 76 form together a triode configuration. Preferably, the cathode layer 71 in this embodiment is molybdenum/titanium metal; the gate electrode layer 74 is molybdenum, and the anode layer 76 is ITO.

The electron emission source paste of this embodiment is coated over the surface of the cathode layer 71, and a voltage potential is applied between the two electrode plates 701 and 702 for testing field emission effects. Meanwhile, a voltage difference is applied between the cathode layer 71 and the gate electrode layer 74 so as to enhance the electron emission effects of the electron emission source.

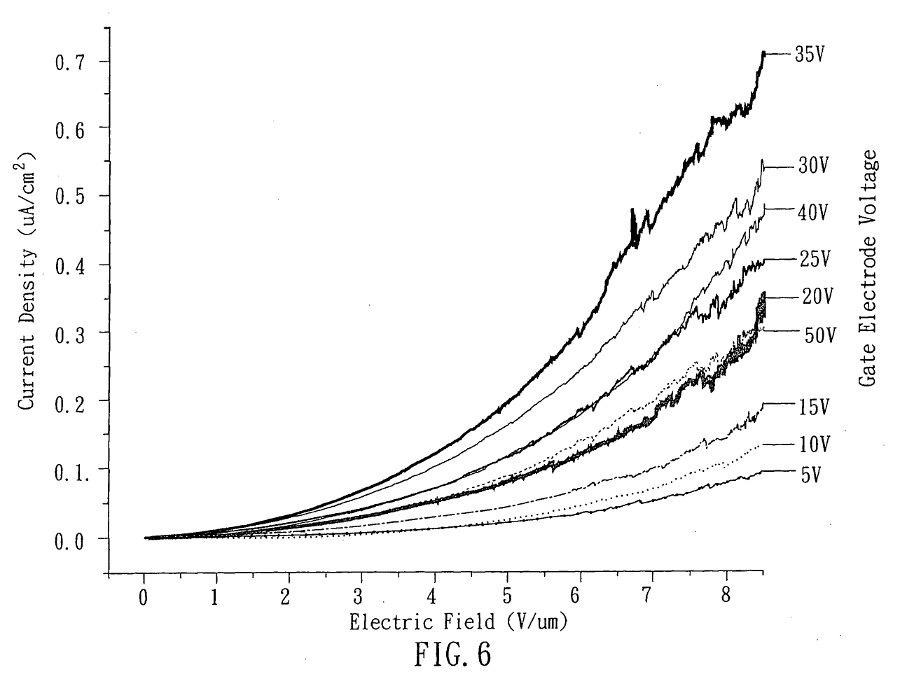

FIG. 6 shows the plot of the field emission effects of the present embodiment. When the electric field applied between the two electrode plates increases, the current density of the electron emission source also increases. Also, as known from FIG. 6, when the voltage difference applied between the cathode layer 71 and the gate electrode layer 74 is incrementally increased from 5V to 35V, the field emission effects are greatly increased. However, this applied voltage difference has its limitations. That is, if the voltage difference is greater than the load that the elements can sustain, such as by applying a voltage difference of 40V and 50V between the cathode layer 71 and the gate electrode layer 74, then most electrons will be attracted towards the gate electrode, causing adverse effects.

Thus, as indicated in the above embodiments, the DLC structure manufactured according to the present invention aids to increase the field emission effects. The DLC not only can be evenly distributed in the electron emission source material, but also the film structure formed on the substrate can be used as the electron emission source. The field emission effects achieved by the two different methods both bear a low starting voltage, a quality favorable for a good cathode electron emission source.

### Embodiment 4

The following is a description about a field emission display according to a preferred embodiment of the invention. The field emission display in this embodiment is similar to the triode-type field emission testing apparatus described in the third embodiment. Aside from an additional phosphor layer and a photo-mask layer on the anode plate, the structure of a lower substrate in this embodiment is the same as that of the third embodiment.

The electron emission source of the field emission display in this embodiment is an electron emission source paste formed by mixing DLC powder, glass powder, silver powder and ethylene cellulose, and coated on the surface of a cathode layer having conductive silver paste, which are then sintered to form an electron emission layer.

In this embodiment, when an electric field is applied between the two electrode plates of the field emission display, where a voltage difference is simultaneously applied between the gate electrode player and the cathode layer, the electron emission source emits electrons to impinge on the phosphor layer of the anode plate so as to cause luminescence.

### Embodiment 5

Aside from the difference in the electron emission sources of the lower substrate, the field emission display in this embodiment is structurally similar to the one shown in the fourth embodiment.

In this embodiment, the surface of the lower substrate includes a molybdenum/titanium metal layer that acts as a cathode layer. The material of the substrate used in this embodiment is glass. Also, the surface of the cathode layer in this embodiment includes a patterned insulating layer and gate electrode layer to partially expose the surface of the cathode. The insulating layer in this embodiment is disposed between the cathode layer and the gate electrode layer to provide electrical insulation.

The above-mentioned lower substrate structure is placed in a sputtering reaction chamber, and undergone a sputtering reaction as described in the first embodiment so as to grow an electron emission layer having a DLC film layer on the exposed cathode surface. Finally, the DLC film layer deposited on the surface of the gate electrode is removed so as to obtain the lower substrate of the field emission display of the present embodiment. The structural characteristic of the DLC film layer in this embodiment is similar to that of the first embodiment.

As described above, according to the present invention, a DLC with micro-scale film structures can be manufactured, that have a high aspect ratio favorable in use as electron emission source material applied in a cold cathode emitting source, such as field emission elements, field emission displays, or flat panel light sources.

Although the present invention has been explained in relation to its preferred embodiment, it is to be understood that many other possible modifications and variations can be made without departing from the scope of the invention as hereinafter claimed.

What is claimed is:

1. An electron emission source, comprising:
a substrate; and
an electron emission layer formed on the surface of the substrate;
wherein the electron emission layer comprises a composition of Diamond-Like Carbon (DLC) flakes with a plurality of micro-scale film structures.

2. The electron emission source as claimed in claim 1, wherein the substrate is constituted of a semiconductor material, a metal material, an insulating material, or a glass material.

3. The electron emission source as claimed in claim 1, wherein the composition further comprises a conductive material, an adhesive material, or a combination thereof.

4. The electron emission source as claimed in claim 1, wherein the film structures are curved film structures, long-strip film structures, or a combination thereof.

5. The electron emission source as claimed in claim 1, wherein the thickness of the film structures is between 0.005 μm and 0.1 μm.

6. The electron emission source as claimed in claim 1, wherein the thickness of the film structures is between 0.005 μm and 0.05 μm.

7. The electron emission source as claimed in claim 1, wherein the lateral height of the film structures is between 0.5 μm and 4.0 μm.

8. The electron emission source as claimed in claim 1, wherein the lateral height of the film structures is between 0.9 μm and 2.0 μm.

9. An electron emission source, comprising:
a substrate;
a conduction layer formed on the surface of the substrate; and
an electron emission layer formed on the surface of the substrate;
wherein the electron emission layer comprises a composition of Diamond-Like Carbon flakes with a plurality of micro-scale film structures.

10. The electron emission source as claimed in claim 9, wherein the substrate is constituted of a semiconductor material, a metal material, an insulating material, or a glass material.

11. The electron emission source as claimed in claim 9, wherein the composition further comprises a conductive material, an adhesive material, or a combination thereof.

12. The electron emission source as claimed in claim 9, wherein the film structures are curved film structures, long-strip film structures, or a combination thereof.

13. The electron emission source as claimed in claim 9, wherein the thickness of the film structures is between 0.005 μm and 0.1 μm.

14. The electron emission source as claimed in claim 9, wherein the thickness of the film structures is between 0.005 μm and 0.05 μm.

15. The electron emission source as claimed in claim 9, wherein the lateral height of the film structures is between 0.5 μm and 4.0 μm.

16. The electron emission source as claimed in claim 9, wherein the lateral height of the film structures is between 0.9 μm and 2.0 μm.

17. A field emission display, comprising:
an upper substrate with a phosphor layer and an anode layer; and
a lower substrate with an electron emission layer and a cathode layer, the electron emission layer being closely adjacent to the cathode layer;
wherein the electron emission source layer comprises a composition of diamond-like carbon flakes with a plurality of micro-scale film structures.

18. The field emission display as claimed in claim 17, wherein the wherein the composition further comprises a conductive material, an adhesive material, or a combination thereof.

19. The field emission display as claimed in claim 17, wherein the film structures are curved film structures, long-strip film structures, or a combination thereof.

20. The field emission display as claimed in claim 17, wherein the lateral height of the film structures is between 0.5 μm and 4.0 μm.

21. The field emission display as claimed in claim 17, wherein the lateral height of the film structures is between 0.9 μm and 2.0 μm.

22. The field emission display as claimed in claim 17, wherein the thickness of the film structures is between 0.005 μm and 0.1 μm.

23. The field emission display as claimed in claim 17, wherein the thickness of the film structures is between 0.005 μm and 0.05 μm.

24. The field emission display as claimed in claim 17, further comprising a gate electrode layer disposed between the cathode plate and the anode plate, the gate electrode layer being a plurality of gate electrodes.

25. The field emission display as claimed in claim 17, wherein the upper substrate further comprises a mask layer closely adjacent to the phosphor layer.
